(19) United States
(12) Patent Application Publication
(10) Pub. No.: US 2008/0226571 A1
(43) Pub. Date: Sep. 18, 2008

(54) Compositions and methods to effect enhanced photoprotection against UV A and UV B induced damage of human skin

(76) Inventor: Muhammed Majeed, Piscataway, NJ (US)

Correspondence Address: SABINSA CORPORATION, 70 ETHEL ROAD WEST, UNIT 6, PISCATAWAY, NJ, 08854, US

(21) Appl. No.: 11/687,039

(22) Filed: Mar. 16, 2007

(51) Int. Cl. A61Q 17/04

(52) U.S. Cl. 424/60; 424/702; 424/727; 424/729; 424/739; 424/757

(57) ABSTRACT

A composition based on labdane-diterpenoids that provides better photo protection against both UV A and UV B radiations in the HaCaT human keratinocyte cell lines is disclosed. The composition comprises 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one. The composition protects the cells of the skin from harmful UV A and UV B rays through synergistic mechanisms with utility as a safe long-term cosmetic solution for preventing UV-induced skin damage and to induce sunless tanning. Additionally, the composition enhances melanogenesis in B16F1 mouse melanoma cells acting as tanning inducers/accelerators both in the presence or absence of sunlight. Elevation of melanogenesis confers additional protection against UV-induced skin damage.

### FIELD OF THE INVENTION

The invention generally relates to compositions based on labdane-diterpenoids that enhance photo protection to UV induced damage of mammalian skin. In particular, a composition comprising 8,13-epoxy-1α,6β,7β,9α-tetrahydroxylabd-14-en-11-one alone and in synergistic combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one that confers enhanced skin photo protection to both UV A and UV B rays while being well tolerated by cells of the skin even at higher concentrations is described.

### BACKGROUND OF THE INVENTION

Sunlight has a profound effect on the skin causing premature skin aging, skin cancer, and a host of skin changes. Exposure to ultraviolet light, particularly UVA or UVB accounts for 90% of the symptoms of premature skin aging.

Skin cancer is a serious consequence of chronic UV exposure. Ultraviolet (UV) radiation from the sun is the main cause of skin cancer. UV rays damage DNA, the genetic material that makes up genes. Genes control the growth and overall health of skin cells. If the genetic damage is severe, a normal skin cell may begin to grow in the uncontrolled, disorderly manner to become cancerous. UV also can cause sunburn, and other damage that makes the skin look prematurely old and wrinkled.

There are different types of skin cancers depending on the type of skin cell from which they arise. Skin cancer can be a basal cell carcinoma, squamous cell carcinoma or malignant melanoma.

The risk groups that are generally predisposed to skin cancer include people with very light skin, people who live in geographic regions closer to the equator, where sunlight is strongest, people who work outdoors or spend lots of time in leisure activities in the sun and people who have already had a diagnosis of skin cancer with a higher-than-normal risk for the disease. These individuals must take great care to minimize UV exposure and follow other preventive measures.

Sunscreen products are known to protect the skin from some of the harmful effects of ultraviolet light exposure. These products contain molecules that absorb the harmful wavelengths of ultraviolet light before they can reach the skin. Sunscreen agents can absorb numerous photons of ultraviolet light in a relatively short period of time.

However, sunscreen products are not perfect in their mode of action. No single sunscreen agent is capable of absorbing all of the harmful wavelengths striking the skin. Higher Sun Protection Factor (SPF) formulations address this problem by including a combination of sunscreen agents in the formulation. However, even when using a combination of sunscreen agents, these products do not provide complete protection, particularly from the longer ultraviolet wavelengths. Although these longer wavelengths do not readily elicit many of the acute damaging effects commonly attributed to ultraviolet light exposure, recent research indicates that these wavelengths can create free radicals in the skin. These free radicals may be responsible for the premature aging of the skin commonly linked to ultraviolet light exposure. The skin possesses defense mechanisms against the generation of ROS. Unfortunately, ultraviolet light entering the skin can easily overwhelm these defense systems.

The relationship between the epidemiology of skin cancer and chronic exposure to ultraviolet radiations has been well documented in several prior art references, some of which have been elucidated herein below.

The research publication titled “Epidemiology of chronic UV-damage” authored by Diepgen T L and published in J Dtsch Dermatol Ges. 2005 September; 3 Suppl 2:S32-5 discusses the relation between chronic UV exposure and the epidemiology of skin cancers in Germany and Europe with comparative figures from Australia.

The review article titled “UV-induced skin cancers” authored by Honigsmann H, Diepgen T L and published in J Dtsch Dermatol Ges. 2005 September; 3 Suppl 2:S26-31 discusses the epidemiology and pathogenetic aspects of UV-induced malignant skin tumours (basal cell carcinoma, squamous cell carcinoma and melanoma).

The research publication titled “Ultraviolet radiation and skin carcinogenesis” authored by Quinn A G and published in Br J Hosp Med. 1997 Sep. 17-30; 58(6):261-4 discusses the recent developments in understanding the epidemiology and molecular biology of skin carcinogenesis caused by chronic UV exposure.

The research publication titled “Etiology of non-melanoma skin cancer” authored by Gjersvik P J. and published in Tidsskr Nor Laegeforen. 2001 Jun. 30; 121(17):2052-6 discusses that UV radiations brings about an immunosuppression of the tumor rejection process in the skin. Further, UV-specific mutations in the p53 tumor suppressor gene are shown to play an important role in both tumor initiation and cell selection.

The research publication titled “UV exposure, skin cancer and decrease in the ozone layer” authored by Rauterberg A, Jung E G. and published in Ther Umsch. 1993 December; 50(12):804-7 elucidates two different risk patterns involved chronic UV exposure and the incidence of skin cancers. The publication also highlights how reduction of ozone in the stratosphere could contribute to a higher incidence of tumors of the skin in the future.

The research publication titled “The epidemiology of UV induced skin cancer” authored by Armstrong B K, Kricker A and published in J Photochem Photobiol B. 2001 October; 63(1-3):8-18 elucidates the epidemiology, incidence rates, risk factors and the preventive measures for UV induced skin cancers namely basal cell carcinoma (BCC), squamous cell carcinoma (SCC) and melanoma.

The research publications titled “Ultraviolet carcinogenesis in nonmelanoma skin cancer. Part I: incidence rates in relation to geographic locations and in migrant populations” published in Skinmed. 2004 January-February; 3(1):29-35; quiz 35-6 and “Ultraviolet carcinogenesis in non melanoma skin cancer part II: review and update on epidemiologic correlations” published in Skinmed. 2004 January-February; 3(1):29-35; quiz 35-6, both the publications authored by Almahroos M, Kurban A K. present epidemiologic evidence attesting the relationship between UV radiation and nonmelanoma skin cancer.

In spite of advances in recent years in the protection of skin from harmful ultraviolet radiation, the epidemic of skin cancer and skin damage from the effects of this radiation has continued unabated. The loss of portions of the ozone layer from environmental pollution is believed to have contributed to an increase in ambient ultraviolet radiation that reaches exposed skin. Many skin protection preparations that could prevent sun damage have an unacceptable odor or texture that discourages their more frequent use, and many of the available skin protectants do not sufficiently protect the skin from these many mechanisms of injury. Further, many skin protection preparations suffer from a poor safety profile. Hence there is a significant public health need for commercially acceptable or improved preparations that can be safely applied to human and animal skin, to offset the harmful effects of ultraviolet radiation.

The use of natural or synthetic compounds derived from plant materials to confer skin photo protection to both UV A and UV B rays has also been reported in prior art references.

European Patent 1443897 to Zelkha, Morris et al on Aug. 11, 2004 describes a method for protecting skin against damages caused by ultra-violet (UV) radiation from the sun by administering a composition containing lycopene from a natural source and one or more carotenoids selected from among phytoene and phytofluene or mixtures thereof.

U.S. Pat. No. 6,455,032 to Kelly, Graham Edmund et al on Sep. 24, 2002 describes a method of protecting skin from either UV-induced immunosuppression or from UV-induced skin damage using a composition containing an extract of soy or clover, and/or the isoflavone compounds genistein, biochanin, dihydro-diadzein, formonentin, dihydro-geneistein, 2-dehydro-O-desmethyl-angolensin, tetrahydro-daidzein, equol, dehydro-equol, O-desmethyl-angolensin, or 6-hydroxy-O-desmethyl-angolensin.

U.S. Application 20030082117 by Martin, Richard et al on Oct. 2, 2002 describes the use of an extract of dedifferentiated cells of the genus Leontopodium plant as ultraviolet radiation filtering agent in a cosmetic method.

U.S. Application 20050003031 by Aylward, James Harrison on Jul. 22, 2004 describes the anti-cancer compounds from plants of species Euphorbia peplus, Euphorbia hirta and Euphorbia drummondii, which may be used to prevent or alleviate damage to skin, caused by ultraviolet irradiation.

U.S. Application 20050070540 by Beauparlant, Pierre on Dec. 1, 2003 describes the uses of diterpenoid compounds extracted from Linum arboretum to prevent skin cancers.

U.S Application 20060105069 by Moffett, Alex et al on Nov. 16, 2005 describes the pharmaceutical, therapeutic, nutritional, cosmetic, and dermatological compositions derived from the pericarp (rind) of the Garcinia mangostana L plant which may be used in the prevention and treatment of skin disease caused by UV-radiations.

U.S Application 20060292255 by Moffett, Alex et al on Jun. 22, 2006 describes the pharmaceutical, therapeutic, nutritional, cosmetic, and dermatological compositions derived from the pericarp (rind) of the Garcinia mangostana L plant which may be used in the prevention and treatment of skin disease caused by UV-radiations.

U.S. Pat. No. 5,824,312 to Unger, Evan C et al on 20 Oct., 1998 describes photo absorptive compounds (UV A and UV B) from the pollens of mesquite, Prosopis juliflora; Mexican palo verde, Parkinsonia aculeata; blue palo verde, Cercidium floridum; or foothills palo verde, Cercidium microphyllum.

U.S Application 20050181079 by Koganov, Michael on Jan. 12, 2005 describes a bioactive composition from Theacea plants that prevent ultraviolet light-induced skin damage.

U.S. Application 20060062858 by de Moraes Barros, Silvia Berlanga et al on Sep. 17, 2003 describes the use of the Pothomorphe umbellata extract to prepare dermocosmetic and/or pharmaceutical compositions for the treatment and/or prevention of photo damage in the skin, cutaneous aging and/or skin cancer caused by excessive exposure to UV radiations.

The root extracts of Coleus Forskohlii are very good sources of physiologically active diterpenes of the Labdane type including 7β-acetoxy-8,13-epoxy-1α,6β,9α-trihydroxylabd-14-en-11-one, 6β-acetoxy-8,13-epoxy-1α,7β,9α-trihydroxylabd-14-en-11-one and 8,13-epoxy-1α,6β,7β,9α-tetrahydroxylabd-14-en-11-one. The ability of forskolin to induce skin pigmentation as a cAMP enhancer is documented in Nature Vol. 443/Sep. 21, 2006. Further, the ability of forskolin to confer skin tanning which would help in photo protection has been discussed in the U.S. Pat. No. 5,332,575 to Redziniak, Gerard et al. on Jul. 26, 2004.

In a quest to find new remedies for problems associated with chronic UV exposure and skin cancers, the present inventors have attempted to study the ability of other natural diterpenes co-occurring with 7β-acetoxy-8,13-epoxy-1α,6β,9α-trihydroxylabd-14-en-11-one in the root extracts of Coleus Forskohlii to naturally enhance skin photo protection to both UV A and UV B rays.

Accordingly, it is the principal object of the present invention to develop a composition based on labdane-diterpenoids containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one to enhance skin photo protection to both UV A and UV B rays.

It is another object of the present invention to develop a composition based on labdane-diterpenoids containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one to enhance skin photo protection to both UV A and UV B rays while maintaining an enhanced safety profile in terms of being well tolerated by the cells of the skin even at higher concentrations.

It is yet another object of the present invention to develop a composition based on labdane-diterpenoids containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one that is cosmetically and dermatologically useful for long-term and high frequency usage at higher concentrations.

Further, the invention aims to develop a composition based on labdane-diterpenoids containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one that can be easily incorporated into topically applied vehicles for directing the active ingredient to a desired portion of the skin or incorporated into oral dosage forms.

Still further, the invention aims at developing a composition based on labdane-diterpenoids containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one to enhance skin photo protection to both UV A and UV B rays through synergistic effects mediated by the actives included in the said composition.

The invention also aims at developing a composition based on labdane-diterpenoids containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one that can be applied alone or in combination with other photo protective agents that enhance the photo protective (UV A and UV B) abilities of the said composition through synergistic mechanisms.

Finally, the invention aims to develop a composition based on labdane-diterpenoids containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one that provides a safe, long-term cosmetic solution to prevent UV-induced skin damage and to additionally induce sunless tanning by naturally promoting melanogenesis.

The present invention fulfills these objectives and provides further related advantages.

### SUMMARY OF THE INVENTION

A composition based on labdane-diterpenoids that enhances photo protection to both UV A and UV B radiations in HaCaT human keratinocyte cell lines is described. The composition comprises 8,13-epoxy-1α,6β,7β,9α-tetrahydroxylabd-14-en-11-one alone (active I) and in combination with 6β-acetoxy-8,13-epoxy-1α,7β,9α-trihydroxylabd-14-en-11-one (active II) and/or 7β-acetoxy-8,13-epoxy-1α,6β,9α-trihydroxylabd-14-en-11-one (active III). The active compounds are obtained from the root extracts of Coleus forskohlii or similar plant sources.

The labdane-diterpenoids based composition of the present invention protects the cells of the skin from harmful UV A and UV B rays through synergistic effects mediated by the actives included therein. The labdane-diterpenoids based composition of the present invention also exhibits an enhanced safety profile in terms of being well tolerated by the cells of the skin even at higher concentrations. The composition is proposed as a long-term cosmetic solution for preventing UV-induced skin damage and to additionally induce sunless tanning by naturally promoting melanogenesis.

The invention presents the following advantageous features.
a) The labdane-diterpenoids based composition of the present invention containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7α-acetoxy-8,13-epoxy-1α,6β,9α-trihydroxylabd-14-en-11-one as the active compounds protects human skin keratinocytes from the damaging effects of both UV A and UV B radiations.
b) The labdane-diterpenoids based composition of the present invention containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one as the active compounds is well tolerated by the human skin even at higher concentrations thus exhibiting an enhanced safety profile.

c) The labdane-diterpenoids based composition of the present invention containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one as the active compounds is cosmetically and dermatologically useful for long-term and high frequency usage.

d) The labdane-diterpenoids based composition of the present invention containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one as the active compounds can be easily incorporated into topically applied vehicles for directing the active ingredient to a desired portion of the skin or incorporated into oral dosage forms.
e) The labdane-diterpenoids based composition of the present invention containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one as the active compounds enhances skin photo protection to both UV A and UV B radiations through synergistic effects mediated by the actives included in the said composition.
f) The labdane-diterpenoids based composition of the present invention containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one as the active compounds can be applied alone or in combination with other photo protective agents that serve to enhance further the photo protective (both UV A and UV B) abilities of the said composition through synergistic mechanisms.
g) The labdane-diterpenoids based composition of the present invention containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one as the active compounds can be used to provide a long-term cosmetic solution to prevent UV-induced skin damage and to induce sunless tanning.
h) The labdane-diterpenoids based composition of the present invention containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one as the active compounds is stable at a pH range of 5-7.
i) As a further related advantage, the labdane-diterpenoids based composition of the present invention containing 8,13-epoxy-1α,6β,7β,9α-tetrahydroxylabd-14-en-11-one alone and in combination with 6β-acetoxy-8,13-epoxy-1α,7β,9α-trihydroxylabd-14-en-11-one and/or 7β-acetoxy-8,13-epoxy-1α,6β,9α-trihydroxylabd-14-en-11-one as the active compounds enhances the intracellular melanin levels of B16F1 mouse melanoma cells in a natural way acting as tanning inducers and accelerators both in the presence and absence of sunlight. Thus, the said composition additionally enhances UV protection by stimulating the melanocytes to produce more melanin in a natural way.

Other features and advantages of the present invention will become apparent from the following more detailed description, taken in conjunction with the accompanying drawings, which illustrate, by way of example, the principle of the invention.

### DETAILED DESCRIPTION OF THE DRAWINGS

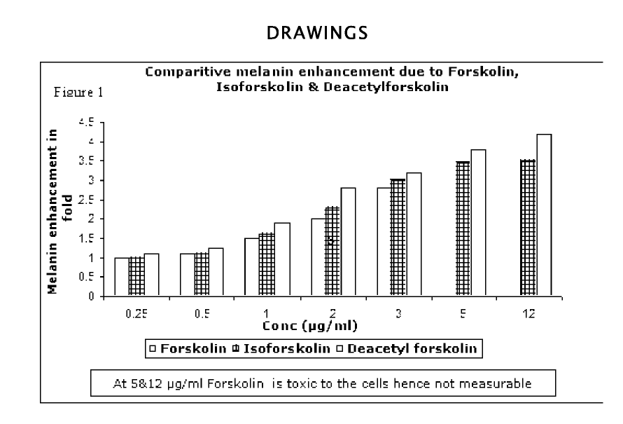

FIG. 1 shows a graphical representation of the comparative UV A protection (%) conferred to HaCaT human keratinocyte cell lines by varying concentrations of active III, congeners of active III (active I and active II) and combinations thereof in a topical application model.

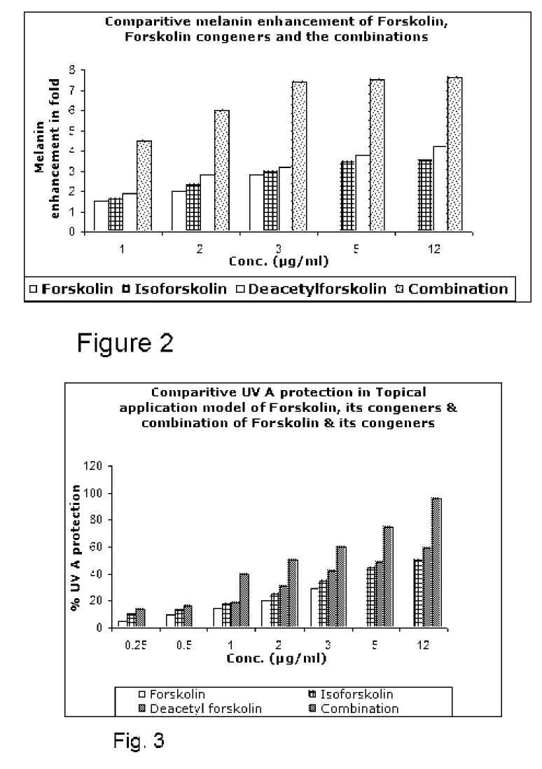

FIG. 2 shows a graphical representation of the comparative UV A protection (%) conferred to HaCaT human keratinocyte cell lines by varying concentrations of active III, congeners of active III (active I and active II) and combinations thereof in an oral application model.

FIG. 3 shows a graphical representation of the comparative UV B protection (%) conferred to HaCaT human keratinocyte cell lines by varying concentrations of active III, congeners of active III (active I and active II) and combinations thereof in a topical application model.

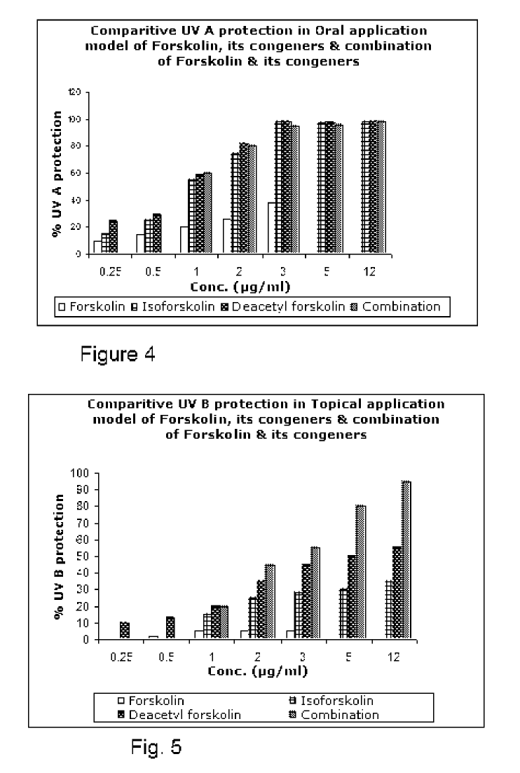

FIG. 4 shows a graphical representation of the comparative UV B protection (%) conferred to HaCaT human keratinocyte cell lines by varying concentrations of active III, congeners of active III (active I and active II) and combinations thereof in an oral application model.

FIG. 5 shows a graphical representation of the comparative melanin enhancement in fold by varying concentrations of active I, active II and active III in the B16F1 mouse melanoma cells.

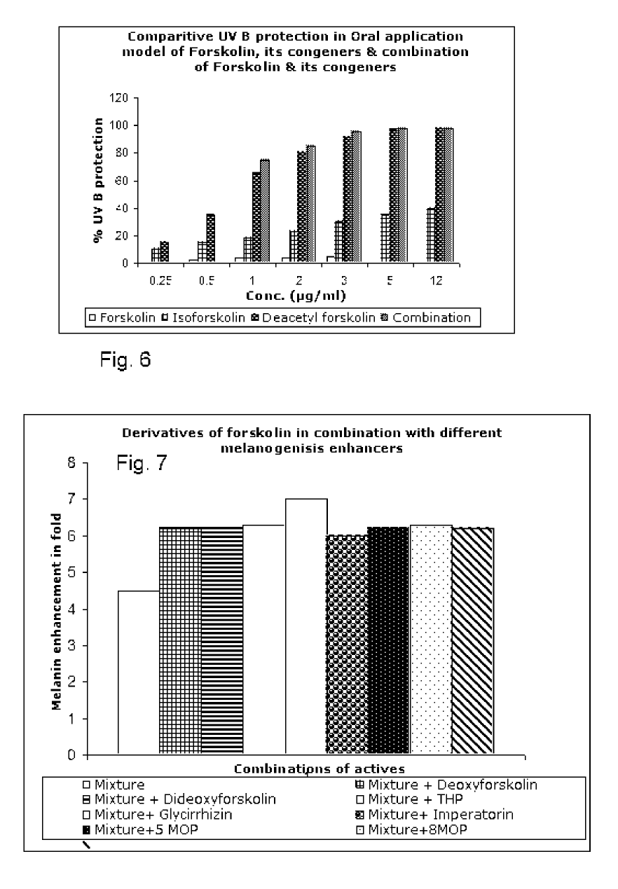

FIG. 6 shows a graphical representation of the comparative melanin enhancement in fold by varying concentrations of active III, congeners of active III (active I and active II) and combinations thereof in B16F1 mouse melanoma cells.

FIG. 7 shows a graphical representation of the comparative melanin enhancement in fold by varying combinations of derivatives of active III with different melanogenesis enhancers in B16F1 mouse melanoma cells.

### DETAILED DESCRIPTION OF THE PREFERRED EMBODIMENT

The present invention provides a composition based on labdane-diterpenoids that enhances photo protection to both UV A and UV B radiations in HaCaT human keratinocyte cell lines. The active labdane-diterpenoids included in the aforesaid composition can be represented by the general formula I wherein the actives are

(a) 8,13-epoxy-1α,6β,7β,9α-tetrahydroxylabd-14-en-11-one (active I) if R1=R2=R3=R4=OH (b) 6β-acetoxy-8,13-epoxy-1α,7β,9α-trihydroxylabd-14-en-11-one (active II) if R2=OCOCH3 and R1=R3=R4=OH and (c) 7β-acetoxy-8,13-epoxy-1α,6β,9α-trihydroxylabd-14-en-11-one (active III) if R1=OCOCH3 and R2=R3=R4=OH.

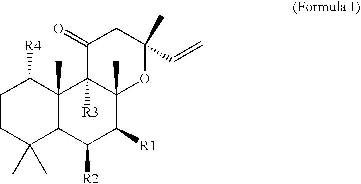

In a preferred embodiment, the labdane-diterpenoids based composition of the present invention comprises 8,13-epoxy-1α,6β,7β,9α-tetrahydroxylabd-14-en-11-one (active I) alone and combination with 6β-acetoxy-8,13-epoxy-α,7β,9α-trihydroxylabd-14-en-11-one (active II) and/or 7β-acetoxy-8,13-epoxy-1α,6β,9α-trihydroxylabd-14-en-11-one (active III).

Actives I, II and III may be obtained from natural plant sources or may be prepared by synthetic means. In a preferred embodiment, actives I, II and III are obtained from natural plant sources selected from a group consisting of Coleus forskohlii, Marrubium cylleneum, Cistus creticus, Amphiachyris amoena, Aster oharai, Otostegia fruticosa, Halimium viscosum and Larix laricema. More preferably, actives I, II and III may be obtained from the root extracts of Coleus forskohlii.

The labdane-diterpenoids based composition of the present invention also comprises synthetic derivatives of actives I, II and III including acetates, propionates, butyrates and physically modified forms such as complexes formed with acceptable cyclodextrins.

In a preferred embodiment, the labdane-diterpenoids based composition of the present invention has concentrations of active I, active II and active III in ratios ranging from 1:1:1 to 2:5:5. More preferably, the concentrations of active I, active II and active III are in the ratio of 1:2:2.

In another preferred embodiment, other photoprotective compounds selected from Licorice extract rich in glycyrrhizin, Licorice extracts rich in glabridin, pomegranate extract, galanga ester, Rosemary extract, selenium derivatives, garcinol, green tea extracts, avobenzone, octyl methoxycinnamate, oxybenzone, dioxybenzone, Coenzyme-Q10, Indian date extract (Tamarindus indicus), Lutein, Zeaxanthin, sulisobenzone, calcium dobesilate, oxyresveratrol, pterosilibins, tetrahydrocurcumins and curcuminoids or combinations thereof may also be included in the labdane-diterpenoids based composition of the present invention. The aforementioned photo protective actives serve to enhance the photo protective abilities of the labdane-diterpenoids based composition of the present invention to both UV A and UV B radiations through synergistic mechanisms.

The labdane-diterpenoids based composition of the present invention can be used to treat subjects who are predisposed to the risks of skin damage associated with acute or chronic UV exposure. The said composition can be administered through topical, oral or intradermal means. The said composition easily can be incorporated into topically applied vehicles such as solutions, suspensions, emulsions, oils, creams, ointments, powders, liniments, salves or the like, as a means of administering the active agents directly to a desired area of the skin. Further, the said composition may also be incorporated into oral dosage forms like capsules, tablets, syrups, toffees, chocolates, functional drinks and the like.

The experimental protocols to determine the ability of the labdane-diterpenoids based composition of the present invention to confer photoprotection to UV A and UV B radiations in HaCaT human keratinocyte cell lines is discussed in detail herein below.

The protocol is based on evaluating the reduction in photo damage caused by UV A and UV B in HaCaT human keratinocyte cell line. The cell viability is measured by Sulphorhodamine B assay (SRB assay) after exposure to UV rays. The percentage of UV protection is calculated based on the number of viable cells in the control (untreated) and test HaCaT human keratinocytes (treated with the labdane-diterpenoids based composition of the present invention) after UV exposure. The photoprotection assays to screen compounds for their UV protection efficacy during topical and oral applications as discussed in J Am Acad Dermatol 2003; 49: 458-472 is adopted as a reference.

Protocol I—Screening compounds suited for topical applications for UV protection efficacy 0.5×10⁴ HaCaT human keratinocyte cells/well are counted and seeded into a 96 well micro titer plates. The cells are incubated at 37° C. in 5% CO₂ for 24 hours. The growth medium is then removed and replaced with medium containing varying concentrations of the labdane-diterpenoids based composition of the present invention. The cells are immediately exposed to ultraviolet irradiation and further incubated for 72 hours. After 72 hours, the cell viability is determined by SRB assay.

Protocol II—Screening compounds suited for oral applications for UV protection efficacy 0.5×10⁴ HaCaT human keratinocyte cells/well are counted and seeded into a 96 well micro titer plates. The cells are incubated at 37° C. in 5% CO₂ for 24 hours. The growth medium is then removed and replaced with medium containing varying concentrations of the labdane-diterpenoids based composition of the present invention. The cells are then incubated for 24 hours to be followed by UV treatment. The UV treated cells are further incubated for 48 hours after which, cell viability is determined using the SRB or neutral red uptake assays.

The UV A exposure in both the protocols involves three UV A bulbs providing 108 watts of power. The plates are exposed for 1 hour at a distance of 5 cm from the source of light. The UV B exposure in both the protocols involves three UV B bulbs which provide 100 μwatt/cm² or 0.14 J/cm² irradiation dose. The plates are exposed for 7 minutes at a distance of 30 cm from the source of light.

In an additional embodiment, the labdane-diterpenoids based composition of the present invention is shown to enhance melanin production in B16F1 mouse melanoma cells through synergistic effects mediated by actives I, II and III included in the composition as mentioned herein above. The said composition may further include other sunless tanning formulations like commercially available bronzers or other melanogenesis stimulating agents. In a preferred embodiment, naturally occurring melanogenesis stimulatory compounds selected from the group consisting of glycyrrhizin, imperatorin, 5-methoxypsoralen, 8-methoxypsoralen, Guggulsterone Z and Guggulsterone E or combinations thereof may be included in the composition. The melanin enhancing property of the said composition may be considered as a further related advantage, wherein the said composition additionally protects the cells of the skin from the deleterious effects of UV radiations by naturally stimulating melanogenesis which causes UV filtration. Further, the said composition can be used to treat subjects with abnormal skin pigmentation disorders, skin hypo pigmentation disorders and total skin depigmentation disorders by stimulating melanogenesis in a natural way.

The experimental protocols to determine the ability of the labdane-diterpenoids based composition of the present invention to enhance levels of intracellular melanin in B16F1 mouse melanoma cells is discussed in detail herein below.

B16F1 mouse melanoma cells are treated with varying concentrations of actives I, II and III and other optional actives or combinations thereof at a time interval of 3 days for nine consecutive days. The intracellular melanin in both the controls and test B16F1 mouse melanoma cells is extracted by 1 N NaOH and subjected to a heat treatment at 100° C. The extracted melanin is estimated at 405 nm in a Fluostar Optima Microplate Reader.

The comparative efficacy of active I, II and III with respect UV A and UV B protection in HaCaT human keratinocyte cell lines, relative cytotoxicity and melanin enhancement abilities in B16F1 mouse melanoma cell lines are summarized in Table 1.

TABLE I

| | | UV protection | | Melanin |
|---|---|---|---|---|
| Compound | Cytotoxicity | UV A | UV B | enhancement |
| Active I | Highly | Significant | Significant | Significant |
| | tolerable | | | |
| Active II | Highly | Moderate | Moderate | Moderate |
| | tolerable | | | |
| Active III | Cytotoxic | Moderate | Nil | Moderate |

A detailed study on the aforesaid properties associated with the labdane-diterpenoids based composition of the present invention is presented as specific examples mentioned herein below.

### EXAMPLE 1

Table A shows the comparative % UV A protection conferred by combinations of active I, active II and active III in both topical and oral application protocols. Table B shows the comparative % UV B protection conferred by combinations of active I, active II and active III in both topical and oral application protocols. FIG. 1 shows a graphical representation of the comparative UV A protection (%) conferred to HaCaT human keratinocyte cell lines by varying concentrations of active III, congeners of active III (active I and active II) and combinations thereof in a topical application model. FIG. 2 shows a graphical representation of the comparative UV A protection (%) conferred to HaCaT human keratinocyte cell lines by varying concentrations of active III, congeners of active III (active I and active II) and combinations thereof in an oral application model. FIG. 3 shows a graphical representation of the comparative UV B protection (%) conferred to HaCaT human keratinocyte cell lines by varying concentrations of active III, congeners of active III (active I and active II) and combinations thereof in a topical application model. FIG. 4 shows a graphical representation of the comparative UV B protection (%) conferred to HaCaT human keratinocyte cell lines by varying concentrations of active III, congeners of active III (active I and active II) and combinations thereof in an oral application model. Tables A and B and FIGS. 1 and 3 indicate the synergistic effect of actives I, II and III in conferring UV A and UV B protection in the topical application protocol.

TABLE A

| | % UV A protection | | | | |
|---|---|---|---|---|---|
| Conc. | Active | | | Conc. in combination of Active | % |
| (μg/ml) | III | Active II | Active I | III + Active II + Active I(μg/ml) | protection |
| Topical | | | | | |
| model | | | | | |
| 0.25 | 5 | 10 | 14 | | |
| 0.5 | 10 | 13 | 16 | | |
| 1 | 15* | 18* | 19 | 0.5 + 0.25 + 0.25 | 40* |
| 2 | 20* | 25* | 31* | 1 + 0.5 + 0.5 | 50* |
| 3 | 29* | 35* | 42* | 1 + 1 + 1 | 60* |
| 5 | toxic | 45* | 49* | 1 + 2 + 2 | 75* |
| 12 | toxic | 50* | 59* | 2 + 5 + 5 | 96* |
| Oral model | | | | | |
| 0.25 | 10 | 15* | 24* | | |
| 0.5 | 15* | 25* | 29* | | |
| 1 | 20* | 55* | 58* | 0.5 + 0.25 + 0.25 | 60* |
| 2 | 26* | 75* | 82* | 1 + 0.5 + 0.5 | 80* |
| 3 | 38* | 98* | 98* | 1 + 1 + 1 | 95* |
| 5 | toxic | 97* | 97* | 1 + 2 + 2 | 96* |
| 12 | toxic | 98* | 98* | 2 + 5 + 5 | 98* |

*‘t’ test, significance: p < 0.05 with respect to control treated group

TABLE B

| Topical | | | | | |
|---|---|---|---|---|---|
| model | % UV A protection as compared to control | | | | |
| Conc. | | | | Conc. in combination of Active | % |
| (μg/ml) | Active III | Active II | Active I | III + Active II + Active I(μg/ml) | protection |
| 0.25 | 0 | 0 | 10 | | |
| 0.5 | 2 | 0 | 13 | | |
| 1 | 5 | 15* | 20* | 0.5 + 0.25 + 0.25 | 20* |
| 2 | 5 | 25* | 35* | 1 + 0.5 + 0.5 | 45* |
| 3 | 5 | 28* | 45* | 1 + 1 + 1 | 55* |
| 5 | toxic | 30* | 50* | 1 + 2 + 2 | 80* |
| 12 | toxic | 35* | 55* | 2 + 5 + 5 | 95* |
| Oral | | | | | |
| model | % UV B protection | | | | |
| 0.25 | 0 | 10* | 15* | | |
| 0.5 | 2 | 15* | 35* | | |
| 1 | 4 | 18* | 65* | 0.5 + 0.25 + 0.25 | 75* |
| 2 | 4 | 23* | 80* | 1 + 0.5 + 0.5 | 85* |
| 3 | 5 | 30* | 91* | 1 + 1 + 1 | 95* |
| 5 | toxic | 35* | 97* | 1 + 2 + 2 | 98* |
| 12 | toxic | 40* | 98* | 2 + 5 + 5 | 98* |

*‘t’ test, significance: p < 0.05 with respect to control treated group

### EXAMPLE 2

FIG. 5 shows a graphical representation of the comparative melanin enhancement in fold by varying concentrations of active I, active II and active III in the B16F1 mouse melanoma cells. The same data is also presented in Table C. It is shown that active I enhances intracellular melanin production in B16F1 cells more than active II or active III. Active II and active I still continue to show enhanced efficacy and tolerability even at dose levels 2.4 times the maximum tolerated dose levels of active III.

TABLE C

| | No. of folds of Melanin Enhancement | | |
|---|---|---|---|
| Concentration | compared to control | | |
| μg/ml | Active III | Active II | Active I |
| 0.25 | 1 | 1 | 1.1 |
| 0.5 | 1.1 | 1.1 | 1.25 |
| 1 | 1.5* | 1.6* | 1.9* |
| 2 | 2* | 2.3* | 2.8* |
| 3 | 2.8* | 3* | 3.2* |
| 5 | toxic | 3.45* | 3.8* |
| 12 | toxic | 3.5* | 4.2* |

*‘t’ test, significance: p < 0.05 with respect to control treated group.
Toxic = Toxic to the cells under the test conditions.

### EXAMPLE 3

FIG. 6 shows a graphical representation of the comparative melanin enhancement in fold by varying concentrations of active III, congeners of active III (active I and active II) and combinations thereof in B16F1 mouse melanoma cells. The same data is also presented in Table D. The combination of actives I, II and III at a concentration of 5 μg/ml and 12 μg/ml result in an optimal point for melanin enhancement.

TABLE D

| Concentration (μg/ml) | | | | Melanin |
|---|---|---|---|---|
| Active III | Active II | Active I | Combination | enhancement |
| 0.5 | 0.25 | 0.25 | 1 | 4.5* |
| 1 | 0.5 | 0.5 | 2 | 6* |
| 1 | 1 | 1 | 3 | 7.4* |
| 1 | 2 | 2 | 5 | 7.5* |
| 2 | 5 | 5 | 12 | 7.6* |

*‘t’ test, significance: p < 0.05 with respect to control treated group

### EXAMPLE 4

Table E shows the folds of melanin enhancement in by varying concentrations of other melanogenesis stimulating actives in B16F1 mouse melanoma cells. It is observed that the melanin enhancement activity of 7β-Acetoxy-6β,9α-dihydroxy-8,13-epoxy-labd-14-en-11-one and 7β-Acetoxy-6β-hydroxy-8,13-epoxy-labd-14-en-11-one is comparable to that of active 3. Melanin enhancement activities of other natural actives such as Glycyrrhizin, Imperatorin, 5-methoxy psoralen (5-MOP), 8-Methoxy psoralen (8-MOP) and Guggulsterones are comparable to active III but inferior to active I. The use of tetrahydropiperine as a penetration enhancer does not show significant melanin enhancement activity and is also found to be toxic to cells.

TABLE E

| | Folds of Melanin Enhancement compared to control | | | | | | |
|---|---|---|---|---|---|---|---|
| | | 7β- | | | | | |
| | 7β- | Acetoxy- | | | | | |
| | Acetoxy- | 6β- | | | | | |
| | 6β,9α- | hydroxy- | | | | | |
| | dihydroxy- | 8,13- | | | | | |
| | 8,13- | epoxy- | | | | | |
| | epoxy- | labd-14- | | | | | |
| Conc. | labd-14- | en-11- | | | | 8- | |
| (μg/ml) | en-11-one | one | Glycyrrhizin | Imperatorin | 5-MOP | MOP | Gugulsterone |
| 0.25 | 1 | 1.1 | 1.82* | 1.08 | 1.1 | 1.12 | 1.15 |
| 0.5 | 1.1 | 1.13 | 2.25* | 1.25 | 1.15 | 1.25 | 1.25 |
| 1 | 1.5* | 1.4* | 2.58* | 1.58* | 1.5* | 1.4* | 1.28 |
| 2 | 1.8* | 2* | 2.76* | 1.78* | toxic | toxic | 1.38 |
| 3 | 2.2* | 2.1* | 2.88* | 2.58* | toxic | toxic | 2.38* |
| 5 | 2.8* | 2.2* | 2.92* | toxic | toxic | toxic | 2.45* |
| 12 | 3.2* | 3* | 2.95* | toxic | toxic | toxic | 2.5* |

*‘t’ test, significance: p < 0.05 with respect to control treated group

### EXAMPLE 5

1 μg of the labdane-diterpenoids based composition of the present invention containing active I, active II and active III in combination with 0.25 μg of other melanogenesis stimulating actives show synergistic effect in stimulating intracellular melanin production in B16F1 mouse melanoma cells. The results are shown in Table F and FIG. 7.

TABLE F

| Labdane- | | | Melanin |
|---|---|---|---|
| diterpenoids | | Total | enhancement |
| composition** | Additives | conc. | in fold |
| 1 ug/ml | No additive | 1 ug/ml | 4.5* |
| 1 ug/ml | 0.25 ug/ml 7β-Acetoxy- | 1.25 ug/ml | 6.2* |
| | 6β,9α-dihydroxy-8,13- | | |
| | epoxy-labd-14-en-11- | | |
| | one | | |
| 1 ug/ml | 0.25 ug/ml 7β-Acetoxy- | 1.25 ug/ml | 6.2* |
| | 6β-hydroxy-8,13- | | |
| | epoxy-labd-14-en-11- | | |
| | one | | |
| 1 ug/ml | 0.25 ug/ml THP | 1.25 ug/ml | 6.3* |
| 1 ug/ml | 0.25 ug/ml Glycyrrhizin | 1.25 ug/ml | 7* |
| 1 ug/ml | 0.25 ug/ml Imperatorin | 1.25 ug/ml | 6* |
| 1 ug/ml | 0.25 ug/ml 5-MOP | 1.25 ug/ml | 6.2* |
| 1 ug/ml | 0.25 ug/ml 8-MOP | 1.25 ug/ml | 6.3* |
| 1 ug/ml | 0.25 ug/ml | 1.25 ug/ml | 6.2* |
| | Guggulsterone | | |

*‘t’ test, significance: p < 0.05 with respect to control treated group
**The composition is 6β-acetoxy-8,13-epoxy-1α,7β,9α-trihydroxylabd-14-en-11-one: 8,13-epoxy-1α,6β,7β,9α-tetrahydroxylabd-14-en-11-one: 7beta-Acetoxy-8,13-epoxy-1□,6□,9□-trihydroxy-labd-14-en-11-one in the concentration ration of 1:2:2

### Applications

1. The labdane-diterpenoids based composition of the present invention are useful for protecting the cells of human skin from the deleterious effects of UV A and UV B radiation in both light skinned and dark skinned individuals.
2. The labdane-diterpenoids based composition of the present invention exhibits an enhanced safety profile in terms of being well tolerated by the cells of the skin even at high concentrations. The said compositions are thus useful for the long-term and high frequency applications on human skin even at high concentrations.
3. The labdane-diterpenoids based composition of the present invention can be easily incorporated into topically applied vehicles such as solutions, suspensions, emulsions, oils, creams, ointments, powders, liniments, salves or the like, as a means of administering the active agents directly to a desired area of the skin or into oral dosage forms like capsules, tablets, syrups, toffees, chocolates, functional drinks and the like.
4. The labdane-diterpenoids based composition of the present invention offers a long-term cosmetic solution to prevent UV-induced skin damage and to induce sunless tanning.
5. The labdane-diterpenoids based composition of the present invention can be combined with other photoprotective agents that may enhance the photoprotective abilities of the said composition through synergistic mechanisms.
6. As a further related advantage, the labdane-diterpenoids based composition of the present invention can be used to enhance the intracellular skin melanin levels serving as a natural tanning inducer and accelerator in the presence or absence of natural sunlight. Elevation of the intracellular melanin levels may confer additional photo protection to UV-induced skin damage.

While the invention has been described with reference to a preferred embodiment, it is to be clearly understood by those skilled in the art that the invention is not limited thereto. Rather, the scope of the invention is to be interpreted only in conjunction with the appended claims.

1. A diterpenoid labdane based composition that enhances photoprotection to both UV A and UV B induced skin damage, said composition comprising deacetylforskolin represented by the general formula I wherein, R1=R2 =R3 =R4 =OH alone or in combination with isoforskolin represented by the general formula I wherein, R2 =OCOCH3 and R1 =R3 =R4 =OH and/or forskolin represented by the general formula I wherein, R1 =OCOCH3 and R2 =R3 =R4 =OH.

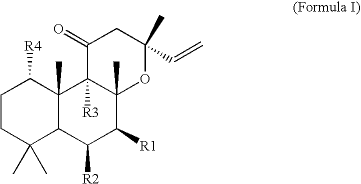

2. The diterpenoid labdane based composition according to claim 1, wherein deacetylforskolin, isoforskolin and forskolin are obtained from natural plant sources selected from a group consisting of Coleus forskohlii, Marrubium cylleneum, Cistus creticus, Amphiachyris amoena, Aster oharai, Otostegia fruticosa, Halimium viscosum and Larix laricema.

3. The diterpenoid labdane based composition according to claim 1, wherein deacetyl forskolin, isoforskolin and forskolin are prepared through synthetic routes.

4. The diterpene labdane based composition according to claim 1, comprising synthetic derivatives of deacetylforskolin, isoforskolin and forskolin including acetates, propionates, butyrates and physically modified forms such as complexes formed with acceptable cyclodextrins.

5. The diterpene labdane based composition according to claim 1, wherein deacetylforskolin, isoforskolin and forskolin are present in concentration ratios ranging from 1:1:1 to 2:5:5.

6. The diterpene labdane based composition according to claim 5, wherein deacetylforskolin, isoforskolin and forskolin are present in a concentration ratio of 1:2:2.

7. The diterpenoid labdane based composition according to claim 1, wherein deacetylforskolin in terms of individual potency confers enhanced photoprotection to both UV A and UV B radiations in comparison to the moderate UV A protection conferred by forskolin.

8. The diterpenoid labdane based composition according to claim 1, wherein deacetylforskolin and isoforskolin are highly tolerated by the cells of the skin even at higher concentrations in comparison to forskolin that is cytotoxic to the cells of the skin at higher concentrations.

9. The diterpenoid labdane based composition according to claim 1 that offers enhanced photo protection to both UV A and UV B induced damage in HaCaT keratinocyte cell lines through synergistic mechanisms mediated by the actives included in the said composition.

10. The diterpene labdane based composition according to claim 1 that exhibits an enhanced safety profile in terms of being well tolerated by the cells of the skin.

11. The diterpene labdane based composition according to claim 1, wherein the said composition offers a safe, long-term therapeutic solution for subjects in need of enhanced photoprotection to both UV A and UV B rays.

12. The diterpene labdane based composition according to claim 9, wherein the subjects are predisposed to the risks of skin cancer due to prolonged UV A and UV B exposure.

13. The diterpene labdane based compositions of claim 9, wherein the said composition may be administered to the subject through topical, oral or transdermal means.

14. The diterpene labdane based composition according to claim 1, wherein the said composition can be incorporated into topically applied vehicles such as solutions, suspensions, emulsions, oils, creams, ointments, powders, liniments, salves or the like, as a means of administering the active agents directly to a desired area of the skin.

15. The diterpene labdane based composition according to claim 1, wherein the said composition can be incorporated into oral dosage forms like capsules, tablets, syrups, toffees, chocolates, functional drinks and the like.

16. (canceled)

17. The diterpenoid labdane composition according to claim 1 that confers additional photo protection to UV A and UV B induced skin damage by inducing melanogenesis in B16 F1 mouse melanoma cells through synergistic mechanisms mediated by the actives included in the said composition.

18. The diterpenoid labdane based composition according to claim 17, wherein deacetylforskolin in terms of individual potency significantly enhances intracellular melanin levels in B 16 F1 mouse melanoma cells in comparison to the moderate enhancement in intracellular melanin levels by both isoforskolin and forskolin.

19. The diterpene labdane based composition according to claim 15, wherein the said composition further includes other sunless tanning formulations like commercially available bronzers or other melanogenesis stimulating agents.

20. (canceled)

21. The diterpene labdane based composition according to claim 17, wherein the said composition may be used to treat subjects with abnormal skin pigmentation disorders, skin hypopigmentation disorders and total skin depigmentation disorders by stimulating melanogenesis in a natural way.

22. The composition based on labdane-diterpenoids according to claim 17, wherein the said composition can be incorporated into topically applied vehicles such as solutions, suspensions, emulsions, oils, creams, ointments, powders, liniments, salves or the like, as a means of administering the active agents directly to a desired area of the skin.

23. The composition based on labdane-diterpenoids according to claim 17, wherein the said composition can be incorporated into oral dosage forms like capsules, tablets, syrups, toffees, chocolates, functional drinks and the like.
